(19) United States
(12) Patent Application Publication
(10) Pub. No.: US 2008/0082456 A1
(43) Pub. Date: Apr. 3, 2008

(54) System and Method for Assessing and Improving the Performance of an Organization

(75) Inventor: Michael L. Goolden, Fairfield, CT (US)

Correspondence Address: Giorgos A. Georgakis;Chowdhury & Georgakis, PC, PO BOX 90277, AUSTIN, TX, 78709-0277, US

(73) Assignee: MLG SYSTEMS, LLC - DBA L7 PERFORMANCE MANAGEMENT, Fairfield, CT (US)

(21) Appl. No.: 11/537,370

(22) Filed: Sep. 29, 2006

(51) Int. Cl. H04L 9/00

(52) U.S. Cl. 705/80

(57) ABSTRACT

Systems and methods for assessing and improving the performance of an organization, including: identifying a business measure; determining whether one or more target values are appropriate for the business measure; determining one or more actual-to-target values for the business measure in response to determining that corresponding target values are appropriate, the actual-to-target values reflecting ratios of actual values to the corresponding target values; determining whether one or more projects for increasing the value of the business measure are appropriate for the business measure; determining one or more project values for the business measure in response to determining that corresponding projects are appropriate, the project values reflecting an on-time completion of the corresponding projects; and weighted-averaging the actual-to-target values and the project values to determine a value of the business measure.

### I. BACKGROUND

A. Field of the Invention

The invention relates generally to assessing and improving the performance of an organization.

B. Description of the Related Art

Business leaders are always faced with the challenge of managing their businesses efficiently and effectively. Many business leaders face similar problems converting strategy to actual results. There can be strategy and prioritization disconnects; tactical execution and accountability disconnects; process, systems, communication, and control disconnects. Often, most employees in the company do not share the same priorities as the company leaders. In addition, the work that may be aligned with the strategic priorities may be delivered late or without ownership and accountability, thereby mitigating the work's potential positive effects. The problem may be compounded by lack of clear visibility to current strategic priorities up and down the line. These problems can adversely lead to wrong decisions that are based on old strategic priorities that are no longer relevant.

### II. SUMMARY

In one respect, disclosed is a method for assessing and improving a performance of an organization, including: identifying a business measure; determining whether one or more target values are appropriate for the business measure; determining one or more actual-to-target values for the business measure in response to determining that one or more corresponding target values are appropriate, the one or more actual-to-target values reflecting ratios of actual values to the one or more corresponding target values; determining whether one or more projects for increasing the value of the business measure are appropriate for the business measure; determining one or more project values for the business measure in response to determining that one or more corresponding projects are appropriate, the one or more project values reflecting an on-time completion of the one ore more corresponding projects; and weighted-averaging the one or more actual-to-target values and the one or more project values to determine a value of the business measure.

In another respect, disclosed is an information handling system comprising: one or more memory units; one or more processor units; one or more input/output devices, and one or more buses coupling the memory, processor, and input/output devices, wherein the system is operable to: identify a business measure; determine whether one or more target values are appropriate for the business measure; determine one or more actual-to-target values for the business measure in response to determining that one or more corresponding target values are appropriate, the one or more actual-to-target values reflecting ratios of actual values to the one or more corresponding target values; determine whether one or more projects for increasing the value of the business measure are appropriate for the business measure; determine one or more project values for the business measure in response to determining that one or more corresponding projects are appropriate, the one or more project values reflecting an on-time completion of the one ore more corresponding projects; and weighted-average the one or more actual-to-target values and the one or more project values to determine a value of the business measure.

In yet another respect, disclosed is a computer program product stored on a computer operable medium, the computer program product comprising software code being effective to: identify a business measure; determine whether one or more target values are appropriate for the business measure; determine one or more actual-to-target values for the business measure in response to determining that one or more corresponding target values are appropriate, the one or more actual-to-target values reflecting ratios of actual values to the one or more corresponding target values; determine whether one or more projects for increasing the value of the business measure are appropriate for the business measure; determine one or more project values for the business measure in response to determining that one or more corresponding projects are appropriate, the one or more project values reflecting an on-time completion of the one ore more corresponding projects; and weighted-average the one or more actual-to-target values and the one or more project values to determine a value of the business measure.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1 is a flow diagram illustrating a method for assessing and improving the performance of an organization, in accordance with one embodiment.

FIG. 2 is a flow diagram illustrating a method for weighted-averaging business measures to determine a performance indicator for an organization, in accordance with one embodiment.

FIG. 3 is a flow diagram illustrating a method for weighted-averaging target values and projects according to their determined effectiveness, in accordance with one embodiment.

FIG. 4 is a flow diagram illustrating a method for weighted-averaging sub-business measures to determine the value of the business measure, in accordance with one embodiment.

FIG. 5 is a diagram illustrating a graphical representation of business measures and the performance indicator, in accordance with one embodiment.

FIG. 6 is a diagram illustrating alternative graphical representations of the values of business measures, in accordance with one embodiment.

FIG. 7 is a table showing a list of projects and a target value for a business measure, in accordance with one embodiment.

FIG. 8 is a block diagram illustrating an information handling system operable to assess the performance of an organization, in accordance with one embodiment.

FIG. 9 is a flow diagram illustrating a method for identifying and overcoming barriers to high performance for an organization, in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

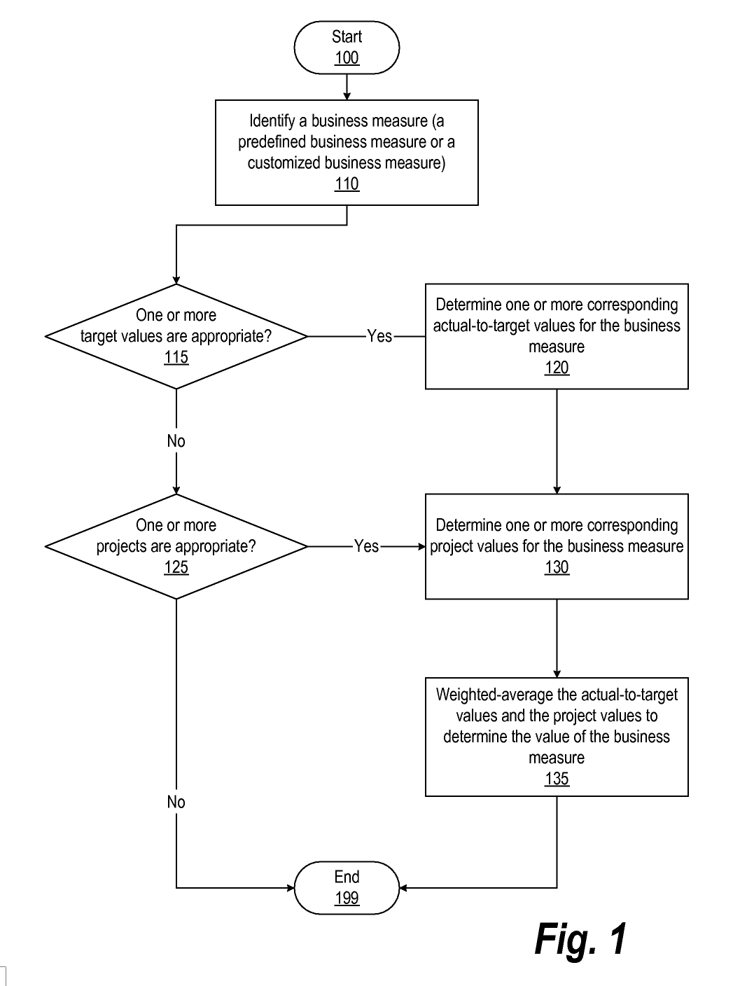

FIG. 1 is a flow diagram illustrating a method for assessing and improving the performance of an organization, in accordance with one embodiment. Processing begins at 100 whereupon, at block 110, a business measure is identified. In one embodiment, the business measure may be weighted-averaged with other business measures to determine a performance indicator for an organization. The business measure may be a predefined business measure or a customized business measure. In one embodiment, the total number of business measures may be limited to seven, as higher numbers of business measures may be difficult for an organization to process efficiently. As will be discussed below, sub-business measures, sub-sub-business measures may also be limited to seven for the same reason.

In one embodiment, predefined business measures are business measures that are preferably adopted as business measures across all organizations for use in assessing and improving the performance of the organization. Predefined business measures may include revenue (such as gross sales and other sales-related measures and activities), income (such as finance-related, CFO/controllership-related, and tax-related measures and activities), employee (such as human resources-related measures and activities), customer (such as marketing-related measures and activities), and compliance (such as internal and/or external vital process control areas related measures and activities). In one embodiment, the number of predefined business measures may be limited to these five business measures.

In one embodiment, customized business measures are business measures that may be customized for each particular organization; chosen to meet the specific needs and characteristics of the particular organization. The customized business measures may be business measures in business areas that drive key results in those business areas. Customized business measures may be, for example, profit-per-store, quality of particular products or services, partner status, new products or services, etc. In one embodiment, the number of customized business measure may be limited to two.

A determination is then made, at decision 115, as to whether one or more target values are appropriate for the evaluation of the business measure. A target value represents an optimum, desired target value for a business measure to reach. If a target value is determined as appropriate for the particular business measure, decision 115 branches to block 120 where a corresponding actual-to-target value is determined. In one embodiment, the actual-to-target value may represent a ratio of the actual (current in some cases) value to a target (desired) value for the business measure. Processing subsequently continues to block 130. The actual-to-target value may be expressed as a percentage or, as will be discussed below, the actual-to-target value may be assigned a number from a numerical scale.

Returning to decision 1 15, if no target values are appropriate, decision 1 15 branches to decision 125 where a determination is made as to whether one or more projects are appropriate for the business measure. A project may be any task with the goal of increasing the value of the business measure. For example, in the case of the revenue business measure, a sales training program may be a project intended to increase the value of the revenue business measure. It should be noted that a project may affect the value (and thus be part of) more than one business measure. If no projects are appropriate (or needed) for the business measure, decision 125 branches to 199 where processing ends.

If one or more projects are determined to be appropriate, decision 125 branches to block 130 where one or more corresponding project values for the business measure are determined. In one embodiment, a project value represents how on-time the completion of a project is. For example, the project value may be a ratio of a number indicating where the completion of a project is (which may be expressed as a percentage) and a number indicating where the completion of a project should be (which may also be expressed as a percentage) according to the project's start and end dates. For example, according to one embodiment, the expected completion of a project over time (in terms of the current time, the start time, and the expected end time) may be given by:

Expected Completion=(t_{current}−tₛₜₐᵣₜ)/(t_{end}−tₛₜₐᵣₜ).

The actual completion value may be manually entered and updated by the user at any given time or it may be determined and entered/updated by other means. The actual completion may be then compared to the expected completion to determine the project value. In one embodiment the project value may then be the ratio of actual to expected completion: Project Value=(Actual Completion)/(Expected Completion). The project value may also be expressed in a numerical scale, such as a scale from one to seven.

In one embodiment, in order to convert either the ratio computed for the actual-to-target value or the project value into the one to seven scale, the following formula may be used:

Scaled Value=FLOOR(ratio*5+1),

where FLOOR is a rounding function that rounds a number to the nearest integer that is smaller than the number.

At block 135, the actual-to-target values and the project values are weighted and then summed (averaged) to determine an overall value for the business measure. Project values and actual-to-target values may be weighted differently according to the importance of each and/or a prediction as to the effectiveness of each. Processing subsequently ends at 199.

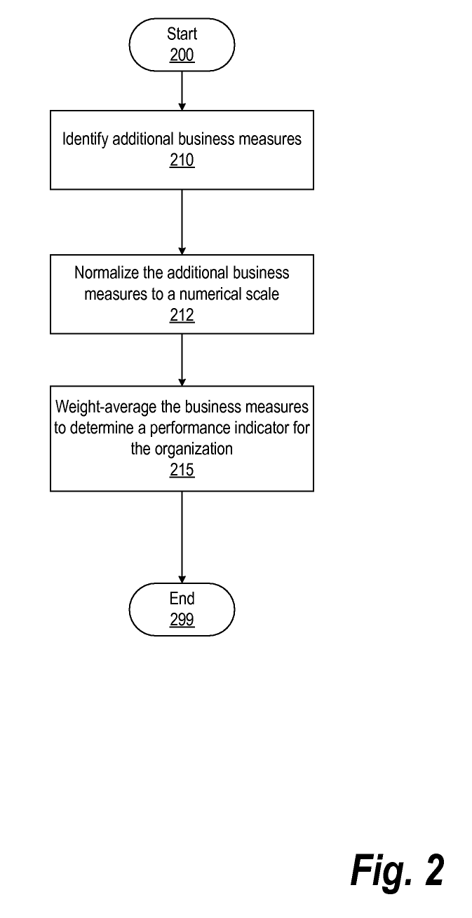

FIG. 2 is a flow diagram illustrating a method for weighted-averaging business measures to determine a performance indicator for an organization, in accordance with one embodiment. Processing begins at 200 where, at block 210, additional business measures are identified. In one embodiment, the total number of business measures may be limited to seven.

At block 212, the business measures are normalized to a common numerical scale. Having a common numerical scale for the business measures facilitates quicker and more effective comparison of the status of each of the business measures. In one embodiment, each of the business measures may be normalized to a numerical scale from one to seven.

At block 215, the business measures are weighted-averaged in order to determine an overall performance indicator for the organization. In one embodiment, the various business measures are first weighted according to each business measure's importance, and then the business measures are averaged to determine the overall performance indicator for the organization.

Processing subsequently ends at 299.

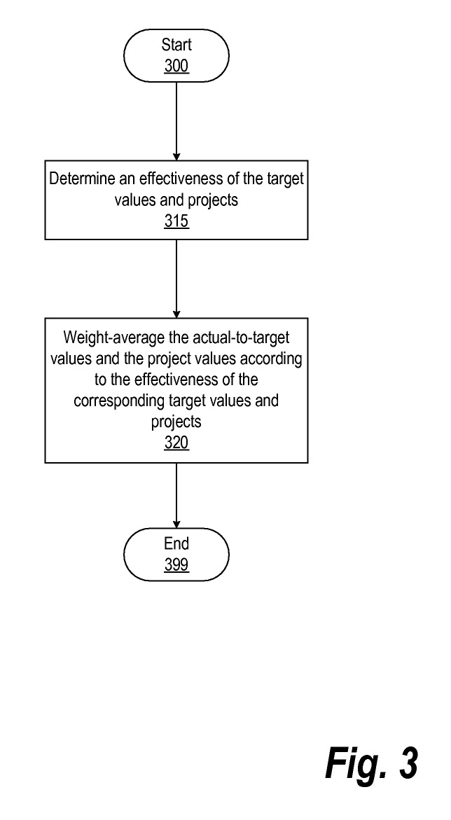

FIG. 3 is a flow diagram illustrating a method for weighted-averaging target values and projects according to their determined effectiveness, in accordance with one embodiment. Processing begins at 300 whereupon, at block 315, the effectiveness of the target values and projects is determined. In one embodiment, the effectiveness may be a prediction or a determination of the impact of each target value or project on the business measure. The effectiveness may be used in the computation, for example, of the weight to be given to each target value and project when averaging the actual-to-target values and the project values to determine the value of a business measure.

At block 320, the actual-to-target values and the project values are weighted-averaged together to determine the value of the business measure according to the effectiveness of each corresponding target value or project. Other considerations may also be used when determining the weight to be given to each of the values.

Processing subsequently ends at 399.

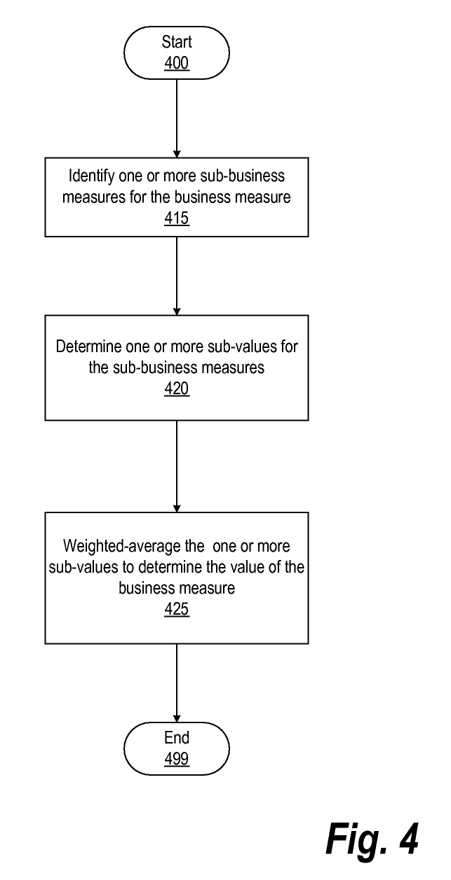

FIG. 4 is a flow diagram illustrating a method for weighted-averaging sub-business measures to determine the value of the business measure, in accordance with one embodiment. Processing begins at 400 whereupon, at block 415, one or more sub-business measures are identified. In one embodiment, one or more of the business measures may be divided into sub-measures to better facilitate the computation of the value of the business measure. It should be noted that, if considered necessary, each sub-business measure may be divided into sub-sub-business measures, etc. In one embodiment, the number of sub-business measures, sub-sub-business measures, etc. may be limited to seven.

At block 420, one or more sub-values corresponding to each of the sub-business measures is determined. In one embodiment, these values may be determined using a process similar to the process used to determine the values of the measures. That is, sub-actual-to-target values and sub-project values may be introduced and computed as needed to determine the value of each sub-business measure.

At block 425, the one or more sub-values are weighted (according to the importance and/or effectiveness of each, for example), and then the sub-values are averaged (summed) to determine the value of the business measure. In the cases where sub-sub-measures, etc. are used, a tree-like process may be used to first compute the values of the sub-sub measures, then the values of the sub-measures, then the values of the business measures, and finally the overall performance factor of the organization.

Processing subsequently ends at 499.

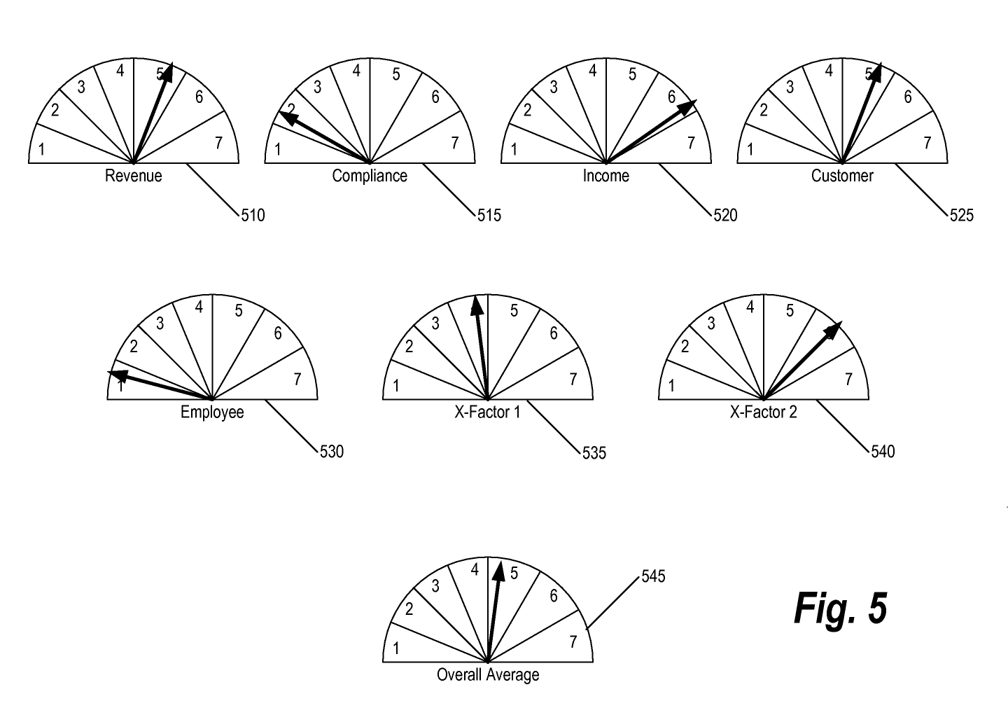

FIG. 5 is a diagram illustrating a graphical representation of business measures and the performance indicator, in accordance with one embodiment. In this example, graph 510 represents the revenue business measure, graph 515 the compliance, graph 520 the income, graph 525 the customer, and graph 530 the employee business measure. Graphs 535 and 540 represent the two customized business measures, which, in one embodiment, are custom-chosen for each organization. Graph 545 is a graphical representation of the overall performance indicator for the organization. Each of the graphs includes a scale from one to seven and an arrow indicating the value of the business measure and the value of the performance indicator. In one embodiment, each of the number scales may also be color (or pattern, etc.)-coded to better indicate the value that each graph depicts. For example, the values 0-3.9 may be colored red, 4.0-5.9 may be colored yellow, and 6.0 and above may be green.

In one embodiment, the results may be presented to a user in real time (to a computer's personal computer, for example) and may be arranged to appear either in a separate window, on the user's desktop, in the user's task bar, etc. Other features may be included as part of the graphs, such as the ability to click on a portion of the graph in order to obtain additional details. For example, clicking on the revenue business measure may provide additional details on the status of the quantities that are being used to compute the value for the revenue business measure.

In another embodiment, all the results (as well as all the sub-results) may be archived in order to facilitate the system's learning from past correlations (such as the correlation between projects and performance increase). Such detailed archiving can allow users to see a snapshot of the organization at any date in the past in a very efficient manner and can allow the users to better design future strategies based on the historical snapshots. This also provides for immediate compliance verifications.

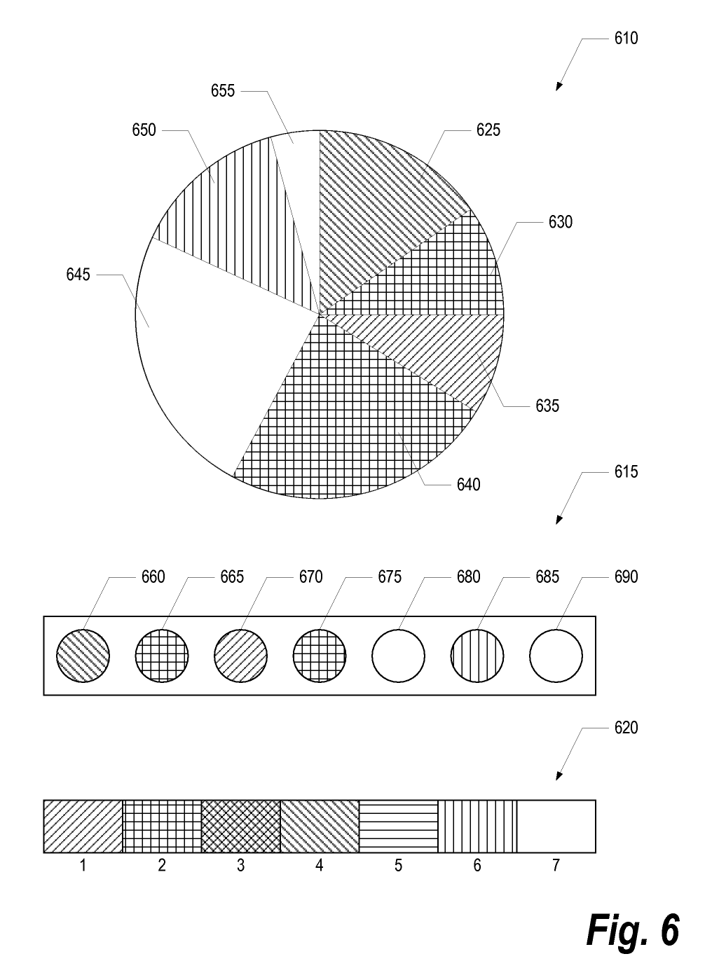

FIG. 6 is a diagram illustrating alternative graphical representations of the values of business measures, in accordance with one embodiment. It should be noted that this chart may also be used to represent the values of sub-business measures, sub-sub-business measures, etc. Scale 620 indicates which values are represented by which patterns (or colors if colors are used). Each of the numbers 1-7 is represented by a different pattern (or color) as seen by the scale.

Pie chart 610 is one alternative representation of the values of each of the business measures. Each of the seven business measures in this example is represented by each section 625, 630, 635, 640, 645, 650, and 655 of the pie chart. The pattern (or color) of each section indicates the value of each of the business measures, in accordance to scale 620. The size of each section represents the weight (which may also indicate the importance) given to each of the business measures. In this example, business measures 640 and 645 appear to have high weights whereas business measure 655 is given a low weight.

Chart 615 represents another alternative representation (in the form of a graph or a toolbar) of the business measures values. Each of the seven business measures is represented by circles 660, 665, 670, 675, 680, 685, and 690. The pattern (or color) of each circle indicates the value of each of the business measures, in accordance to scale 620. In one embodiment, an additional circle may be present to represent the overall performance factor of the organization—a weighted-average of all the business measures.

In one embodiment, the results may be presented to a user in real time (to the user's personal computer, for example) and may be arranged to appear either in a separate window, on the user's desktop, in the user's task bar, etc. Other features may be included as part of the graphs, such as the ability to click on a portion of the graph in order to obtain additional details. For example, clicking on the revenue business measure may provide additional details on the measures used to compute the value for the revenue business measure. Additional details may also be provided to the user when the user floats a pointing device, such as a mouse, over different portions of the graph/toolbar.

In one embodiment, the graph/toolbar may be provided to a selected group of employees or to all of the employees of the organization in order to make the employees across the whole organization aware of the status of the performance of the organization, facilitating greater awareness of the goals and direction of the organization.

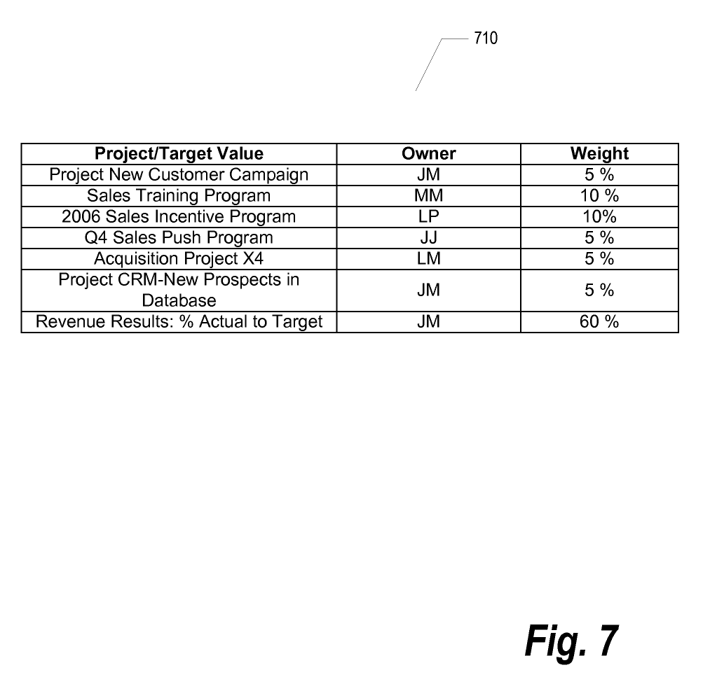

FIG. 7 is a table showing a list of projects and a target value for a business measure, in accordance with one embodiment.

Table 710 includes a column with the name/description of each project/target value, a column that indicates the user responsible for the project/target value (owner), and a percent column indicating the weight to be given to each project/target value during the averaging/summation. In the example shown, the business measure revenue is shown.

In one embodiment, the weights for each project/target value are chosen in accordance to the importance/effectiveness of each project/target value. An owner may be assigned to each project/target value for accountability purposes. If the value of a project/target is not satisfactory, for example, a manager, CEO, etc. will know whom to hold accountable for that particular project's/target's unsatisfactory performance.

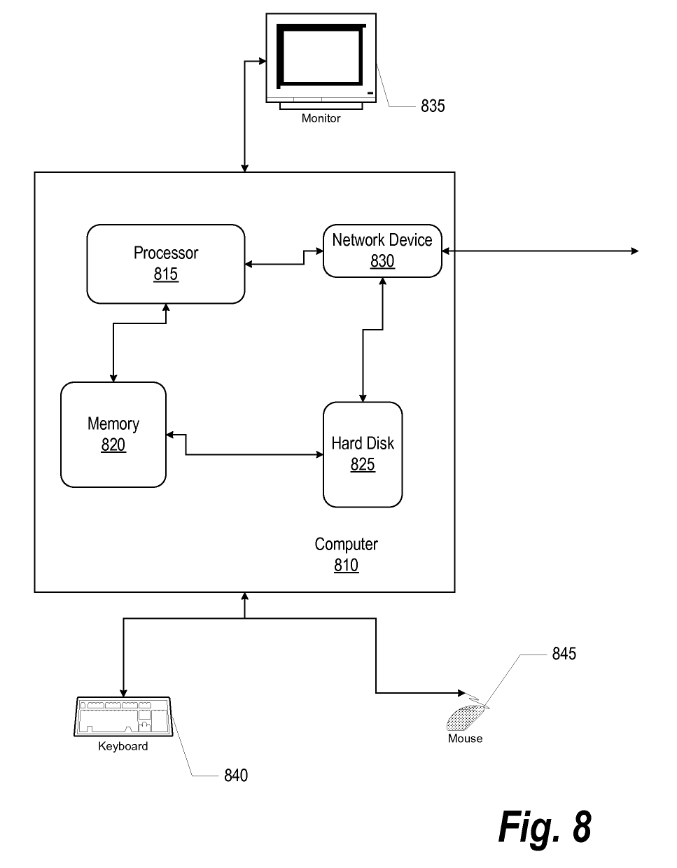

FIG. 8 is a block diagram illustrating an information handling system operable to assess the performance of an organization, in accordance with one embodiment.

The information handling system may include software or hardware or both in order to be operable to perform the function(s) claimed herein. In the example shown in the figure, the information handling system includes memory 820, processor 815, hard disk 825, input/output/network unit 830, keyboard 840, pointing device 845, and display monitor 835. Other configurations for the information handling system are possible.

It should also be noted that the system may be accessed over a network (such as the internet) through a browser (such as a web browser) either for updating data or monitoring purposes. A user need not have a particular application installed on the user's personal computer. Such a web-based system would be more easily accessible by more people in an organization.

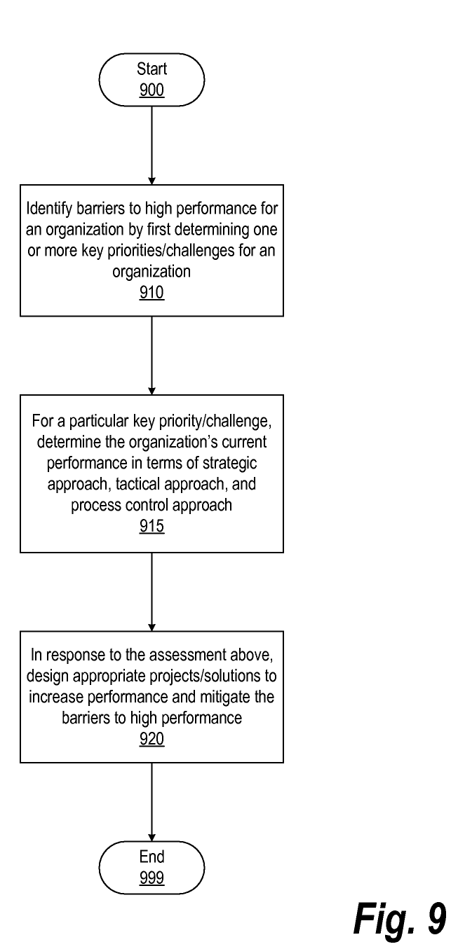

FIG. 9 is a flow diagram illustrating a method for identifying and overcoming barriers to high performance for an organization, in accordance with one embodiment.

Processing begins at 900 whereupon, at block 910, barriers to high performance are identified for an organization by first determining one or more key priorities/challenges for that particular organization. For example, a key priority/challenge for a particular organization may be a certain corporate acquisition.

At block 915, for a particular key priority/challenge, a determination is made as to the organization's current performance in terms of strategic approach, tactical approach, and process control approach. The strategic evaluation may include, for example, examining the quality of strategic initiatives relative to this area and the prioritization and focus of this area throughout the business. The tactical evaluation may include, for example, examining the tactical execution delivered on time of key tasks relative to this area and the accountability of individuals on key projects relative to this area. The process control approach may include, for example, examining the process and systems controls relative to this area, the communication and awareness relative to this area, and the alignment and team effort relative to this area. In one embodiment, each item may be rated on a scale from one to seven.

At block 920, in response to above assessment, one or more appropriate projects/solutions are designed to increase the performance and mitigate the barriers to high performance. Processing subsequently ends at 999.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for assessing and improving a performance of an organization, the method comprising:
identifying a business measure;
determining whether one or more target values are appropriate for the business measure;
determining one or more actual-to-target values for the business measure in response to determining that one or more corresponding target values are appropriate, the one or more actual-to-target values reflecting ratios of actual values to the one or more corresponding target values;
determining whether one or more projects for increasing the value of the business measure are appropriate for the business measure;
determining one or more project values for the business measure in response to determining that one or more corresponding projects are appropriate, the one or more project values reflecting an on-time completion of the one ore more corresponding projects; and
weighted-averaging the one or more actual-to-target values and the one or more project values to determine a value of the business measure.

2. The method of claim 1, further comprising reporting the value of the business measure in real time.

3. The method of claim 1, further comprising:
identifying additional business measures;
normalizing the business measures to a numerical scale; and
weighted-averaging the business measures to determine a performance indicator for the organization.

4. The method of claim 3, wherein the business measures are either a predefined business measure or a customized business measure, the method further comprising limiting a total number of the one or more predefined business measures to five and the one or more customized business measures to two.

5. The method of claim 1, further comprising assigning a responsible owner to one or more of the target values or to one or more of the project values.

6. The method of claim 1, further comprising:
determining an effectiveness of the one or more target values and of the one or more projects; and
weighted-averaging the one or more actual-to-target values and the one or more projects values according to the effectiveness of the one or more target values and the one or more projects.

7. The method of claim 1, further comprising:
identifying one or more sub-business measures for the business measure;
determining one or more sub-values corresponding to the one or more sub-business measures; and
weighted-averaging the one or more sub-values to determine the value of the business measure.

8. The method of claim 7, further comprising limiting a total number of sub-business measures to seven.

9. An information handling system comprising:
one or more memory units;
one or more processor units;
one or more input/output devices, and one or more buses coupling the memory, processor, and input/output devices, wherein the system is operable to:
identify a business measure;
determine whether one or more target values are appropriate for the business measure;
determine one or more actual-to-target values for the business measure in response to determining that one or more corresponding target values are appropriate, the one or more actual-to-target values reflecting ratios of actual values to the one or more corresponding target values;
determine whether one or more projects for increasing the value of the business measure are appropriate for the business measure;
determine one or more project values for the business measure in response to determining that one or more corresponding projects are appropriate, the one or more project values reflecting an on-time completion of the one ore more corresponding projects; and
weighted-average the one or more actual-to-target values and the one or more project values to determine a value of the business measure.

10. The system of claim 9, the system being further operable to report the value of the business measure in real time.

11. The system of claim 9, the system being further operable to:
identify additional business measures;
normalize the business measures to a numerical scale; and
weighted-average the business measures to determine a performance indicator for the organization.

12. The system of claim 11, wherein the business measures are either a predefined business measure or a customized business measure, the system being further operable to limit a total number of the one or more predefined business measures to five and the one or more customized business measures to two.

13. The system of claim 9, the system being further operable to assign a responsible owner to one or more of the target values or to one or more of the project values.

14. The system of claim 9, the system being further operable to:
determine an effectiveness of the one or more target values and of the one or more projects; and
weighted-average the one or more actual-to-target values and the one or more project values according to the effectiveness of the one or more target values and of the one or more projects.

15. The system of claim 9, the system being further operable to:
identify one or more sub-business measures for the business measure;
determine one or more sub-values corresponding to the one or more sub-business measures; and
weighted-average the one or more sub-values to determine the value of the business measure.

16. The system of claim 15, the system being further operable to limit a total number of sub-business measures to seven.

17. A computer program product stored on a computer operable medium, the computer program product comprising software code being effective to:
identify a business measure;
determine whether one or more target values are appropriate for the business measure;
determine one or more actual-to-target values for the business measure in response to determining that one or more corresponding target values are appropriate, the one or more actual-to-target values reflecting ratios of actual values to the one or more corresponding target values;
determine whether one or more projects for increasing the value of the business measure are appropriate for the business measure;
determine one or more project values for the business measure in response to determining that one or more corresponding projects are appropriate, the one or more project values reflecting an on-time completion of the one ore more corresponding projects; and
weighted-average the one or more actual-to-target values and the one or more project values to determine a value of the business measure.

18. The product of claim 17, the code being further effective to report the value of the business measure in real time.

19. The product of claim 17, the code being further effective to:
identify additional business measures;
normalize the business measures to a numerical scale; and
weighted-average the business measures to determine a performance indicator for the organization.

20. The product of claim 19, wherein the business measures are either a predefined business measure or a customized business measure, the code being further effective to limit a total number of the one or more predefined business measures to five and the one or more customized business measures to two.

21. The product of claim 17, the code being further effective to assign a responsible owner to one or more of the target values or to one or more of the project values.

22. The product of claim 17, the code being further effective to:
determine an effectiveness of the one or more target values and of the one or more projects; and
weighted-average the one or more actual-to-target values and the one or more project values according to the effectiveness of the one or more target values and of the one or more projects.

23. The product of claim 17, the code being further effective to:
identify one or more sub-business measures for the business measure;
determine one or more sub-values corresponding to the one or more sub-business measures; and
weighted-average the one or more sub-values to determine the value of the business measure.

24. The product of claim 23, the code being further effective to limit a total number of sub-business measures to seven.
